(19) United States
(12) Patent Application Publication
(10) Pub. No.: US 2020/0360816 A1
(43) Pub. Date: Nov. 19, 2020

(54) Capturing Subject Representation Within an Augmented Reality Environment

(71) Applicant: Microsoft Technology Licensing, LLC, Redmond, WA (US)

(72) Inventors: Jason Matthew CAHILL, Woodinville, WA (US); Jesse Dylan MERRIAM, Bothell, WA (US); Torfi Frans OLAFSSON, Kirkland, WA (US); Timothy James SCHUTZ, Duvall, WA (US)

(73) Assignee: Microsoft Technology Licensing, LLC, Redmond, WA (US)

(21) Appl. No.: 16/414,567

(22) Filed: May 16, 2019

(51) Int. Cl. A63F 13/655; G06T 19/00; A63F 13/216; A63F 13/213

(52) U.S. Cl. CPC A63F 13/655; A63F 13/213; A63F 13/216; G06T 19/006

(57) ABSTRACT

Described herein is a system and method of generating self-portrait within augmented realty session. A first camera of a device can capture an image of user(s) in a physical environment (e.g., real-world). A depth sensor can determine a distance of the user(s) from the device. A second camera of the device can determine an orientation and/or change of orientation of the device in the physical environment. Virtual object(s) in proximity to the user(s) can be determined based, at least in part, upon the determined physical location and determined orientation of the user gaming device. Each virtual object can have an associated physical location within the physical environment. A representation of the identified virtual object(s) can then be generated and an AR self-portrait can be generated based, at least in part, the captured representation of the user in the physical environment and the generated representation of the identified virtual object(s).

### BACKGROUND

Augmented reality (AR) systems such as video games display real world images overlaid with a virtual experience (e.g., interactive three-dimensional object(s)). An AR system thus enables a participant to view real-world imagery in combination with context-relevant, computer-generated imagery (e.g., virtual object(s)). Imagery from the real-world and the computer-generated are combined and presented to a user such that they appear to share the same physical space.

AR video games can include a virtual environment that parallels at least parts of a physical environment. A user can be represented in the virtual environment as an avatar. User movement(s) within the physical environment (e.g., real world) can cause corresponding avatar movement(s) within the virtual environment. For example, during gameplay, as a user walks down a particular street, the user's avatar can be moved down a corresponding street in the virtual environment.

### SUMMARY

Described herein a system for generating an augmented reality subject representation, comprising: a computer comprising a processor and a memory having computer-executable instructions stored thereupon which, when executed by the processor, cause the computer to: capture a representation of a subject in a physical environment using a first camera of a user gaming device; determine a distance of the subject from the user gaming device using a depth sensor; determine a physical location of the user gaming device in the physical environment; determine an orientation of the user gaming device in the physical environment using a second camera of the mobile device; identify one or more virtual objects in proximity to the subject based, at least in part, upon the determined physical location of the user gaming device and the determined orientation of the user gaming device, each virtual object having an associated physical location within the physical environment; generate a graphical representation of the identified one or more virtual objects based, at least in part, upon the determined distance of the subject from the user gaming device, the determined physical location of the user gaming device, the determined orientation of the user gaming device, and, the identified one or more virtual objects in proximity to the subject; generate the augmented reality subject representation based, at least in part, upon the captured representation of the subject in the physical environment, and, the generated graphical representation of the one or more identified one or more virtual objects; and, display the generated augmented reality subject representation on a display of the user gaming device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for generating an augmented reality subject representation.

FIG. 2 is a diagram illustrating a subject using a user gaming device to take a self-portrait with a virtual object.

FIG. 3 is an exemplary user interface.

FIG. 4 is a diagram illustrating the subject having moved the user gaming device.

FIGS. 5-7 are exemplary user interfaces.

FIGS. 8 and 9 are a flow chart that illustrates a method of generating an augmented reality subject representation.

FIG. 10 is a flow chart that illustrates a method of a method of viewing a generated augmented reality subject representation.

FIG. 11 is a functional block diagram that illustrates an exemplary computing system.

### DETAILED DESCRIPTION

Various technologies pertaining to capturing subject representation(s) within an augmented reality environment are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding capturing subject representation(s) within an augmented reality environment. What follows are one or more exemplary systems and methods.

Aspects of the subject disclosure pertain to the technical problem of capturing representation(s) within an AR environment. The technical features associated with addressing this problem involve capturing a representation of a subject in a physical environment using a first camera of a user gaming device; determining a distance of the subject from the user gaming device using a depth sensor; determining a physical location of the user gaming device in the physical environment; determining an orientation of the user gaming device in the physical environment using a second camera of the mobile device; identifying one or more virtual objects in proximity to the subject based, at least in part, upon the determined physical location of the user gaming device and the determined orientation of the user gaming device, each virtual object having an associated physical location within the physical environment; generating a graphical representation of the identified one or more virtual objects based, at least in part, upon the determined distance of the subject from the user gaming device, the determined physical location of the user gaming device, the determined orientation of the user gaming device, and, the identified one or more virtual objects in proximity to the subject; generating the augmented reality subject representation based, at least in part, upon the captured representation of the subject in the physical environment, and, the generated graphical representation of the one or more identified one or more virtual objects; and, displaying the generated augmented reality subject representation on a display of the user gaming device. Accordingly, aspects of these technical features exhibit technical effects of more efficiently and effectively locating virtual object(s) within a physical environment, for example, reducing consumption of computer resource(s) and/or network bandwidth.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

As used herein “user gaming device” refers to a moveable individual computing device including, for example, a mobile phone, a laptop, a tablet, a phablet, a personal digital assistant (“PDA”), an e-reader, a wearable computer, a head-mounted display (HMD), or any other moveable computing device having components for interacting with a virtual reality system and/or an augmented reality system.

Virtual reality video games can include a virtual environment that parallels at least parts of a physical environment. A user can be represented in the virtual environment, for example, as an avatar. User movement(s) within the physical environment (e.g., real world) can cause corresponding movement(s) (e.g., of the avatar) within the virtual environment as displayed on a user gaming device. Augmented reality video games display a real world image and/or video overlaid with a virtual gaming experience (e.g., interactive three-dimensional object(s)).

In order to provide a rich gaming experience, virtual object(s) (e.g., interactive virtual object(s)) can be dispersed throughout specific physical area(s) where gaming (e.g., virtual reality gaming and/or augmented reality gaming) is expected and/or encouraged to occur, with each virtual object having an associated physical location. In this manner, particular virtual object(s) can be displayed on a user gaming device (e.g., mobile phone) when a user is in physical proximity of the associated physical location associated with the particular virtual object(s) (e.g., within a threshold distance of the physical location associated with the particular virtual object(s)). In some embodiments, the physical location associated with a particular virtual object can change with time (e.g., minute, hour, day, month, season, etc.) and/or as part of an augmented reality video game (e.g., virtual object(s) are selectively accessible during gameplay as determined by the augmented reality video game). In some embodiments, the virtual object associated with a particular physical location can change with time (e.g., minute, hour, day, month, season, etc.) and/or as part of an augmented reality video game.

Described herein is a system and method of generating an augmented reality subject representation (e.g., self-portrait within augmented realty session). In some embodiments, in response to selection of a selfie mode during an AR session, a first camera (e.g., front-facing camera) of a mobile device mobile phone) can capture an image and/or video of one or more user(s) in a physical environment (e.g., real-world image or video). The first camera can also comprise a depth sensor and can determine a distance of the one or more user(s) from the mobile device. A second camera (e.g., rear-facing camera) of the mobile device can determine an orientation and/or change of orientation of the user gaming device in the physical environment.

Virtual object(s) in proximity to the user(s) can be determined based, at least in part, upon the determined physical location and determined orientation of the mobile device, with each virtual object having an associated physical location within the physical environment. A representation of the identified one or more virtual objects can then be generated based, at least in part, upon the determined distance of the user from the mobile device, the determined physical location of the mobile device, the determined orientation of the mobile device, and, the identified virtual object(s) in proximity to the user. An AR self-portrait can be generated based, at least in part, upon overlaying (e.g., combining) the captured representation (e.g., image and/or video) of the user in the physical environment with the generated representation of the identified virtual object(s).

The user can view the generated AR self-portrait using a display of the mobile device. The user can alter a position of the user in the physical environment, the position of the mobile device in the physical environment, and/or the orientation of the mobile device in the physical environment. The system can generate AR self-portrait(s) in response to these alteration(s) which are displayed on the mobile device. When the user is satisfied with the AR self-portrait(s), the user can cause the generated AR self-portrait(s) to be stored (e.g., in memory of the mobile device and/or in cloud-based storage).

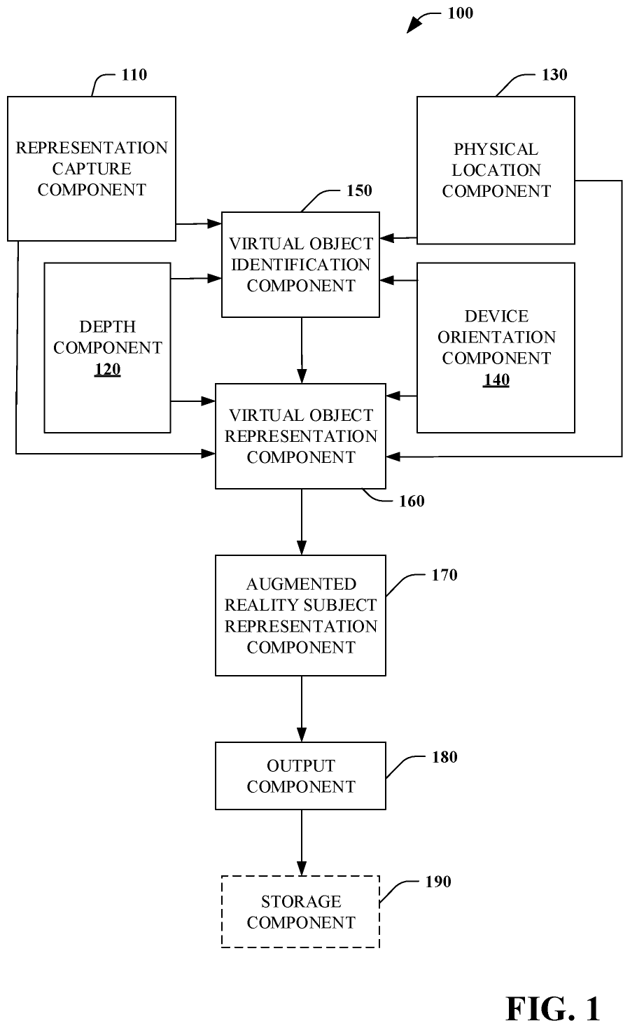

Referring to FIG. 1, a system for generating an augmented reality subject representation 100 is illustrated. In some embodiments, the system 100 is a component of a user gaming device (not shown). In some embodiments, component(s) of the system 100 are resident on the user gaming device with other component(s) resident in a cloud-based augmented reality game system (not shown).

In some embodiments, the system 100 can generate an AR self-portrait (e.g., selfie) of a user with virtual object(s) having associated physical location(s) (e.g., each virtual object anchored/grounded to a respective physical location within the physical environment). For example, the user can be engaged in a virtual reality game that parallels at least parts of the physical environment. Based upon the user's physical location, a real world image and/or video can be overlaid with one or more virtual object(s) (e.g., interactive three-dimensional object(s)) viewable using a user gaming device. The user can select a representation capture mode (e.g., selfie mode), with the system 100 providing an AR self-portrait of the user with the virtual object(s).

The system 100 includes a representation capture component 110 that captures a representation of a subject (e.g., person(s), animal(s), and/or other object(s)) in a physical environment. The representation capture component 110 can comprise a first camera of a user gaming device. In some embodiments, the first camera is a front-facing camera of the user gaming device. In some embodiments, the first camera is a rear-facing camera of the user gaming device.

In some embodiments, the representation comprises an image (e.g., picture) of the subject in the physical environment. In some embodiments, the representation comprises a video of the subject in the physical environment. In some embodiments, the representation comprises audio of the subject in the physical environment.

The system 100 further includes a depth component 120 that determines a distance of the subject from the user gaming device using a depth sensor (e.g., camera). In some embodiments, the depth sensor is integral to the first camera of the user gaming device. In some embodiments, the depth sensor is integral to the second camera of the user gaming device. In some embodiments, the depth sensor is a separate component of the user gaming device.

The system 100 also includes a physical location component 130 that determines a physical location of the user gaming device in the physical environment. In some embodiments, the physical location of the user gaming device is determined based, at least in part, using a second camera (e.g., different from the first camera) of the user gaming device. In some embodiments, the second camera is a rear-facing camera of the user gaming device. In some embodiments, the second camera is a front-facing camera of the user gaming device. In some embodiments, the physical location of the user gaming device is determined using the global position system (GPS) and/or WiFi (e.g., 802.11mc).

The system 100 includes a device orientation component 140 that determines an orientation and/or change of orientation (e.g., six degrees of position) of the user gaming device in the physical environment. “Six degrees of position” (also referred to as “six degrees of freedom”) refers to freedom of movement of an object in three-dimensional space along three orthogonal spatial axes (e.g., x, y, and z) and a change in object orientation about three orthogonal rotation axes (e.g., yaw, pitch, and roll). In some embodiments, the device orientation component 140 comprises the second camera of the user gaming device.

In some embodiments, the device orientation component 140 can utilize real-time camera pose tracking that requires computing pixel correspondence across different frames and solving the optimal transform from a reference frame to the current frame. This process is called Simultaneous Localization and Mapping (SLAM).

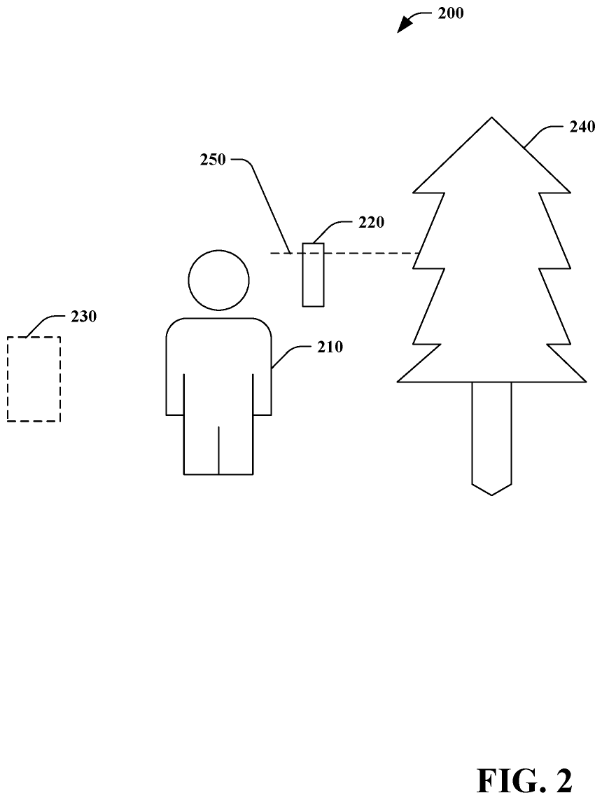

Referring briefly to FIG. 2, a diagram 200 illustrating a subject 210 using a user gaming device 220 to take a self-portrait with a virtual object 230. A rear-facing camera of the user gaming device 220 utilizes an object 240 of the physical environment (e.g., real world) to perform simultaneous localization and mapping along a first three-dimensional axis 250 (e.g., orthogonal to plane of the user gaming device 220).

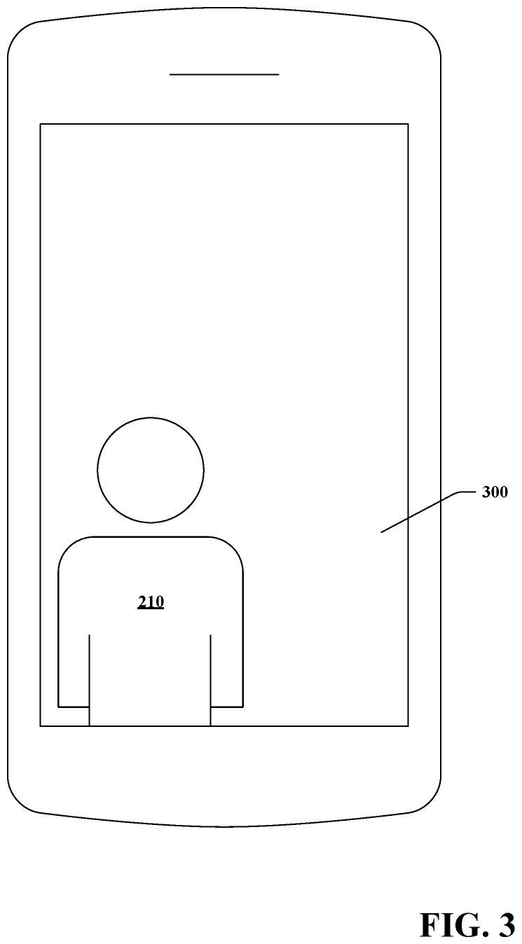

As illustrated in the exemplary user interface 300 of FIG. 3, with the positioning of the user gaming device 220, the virtual object 230 which has a size and an associated position in the real world, is not visible on a display 310 of the user gaming device 220, as initially generated by the system 100.

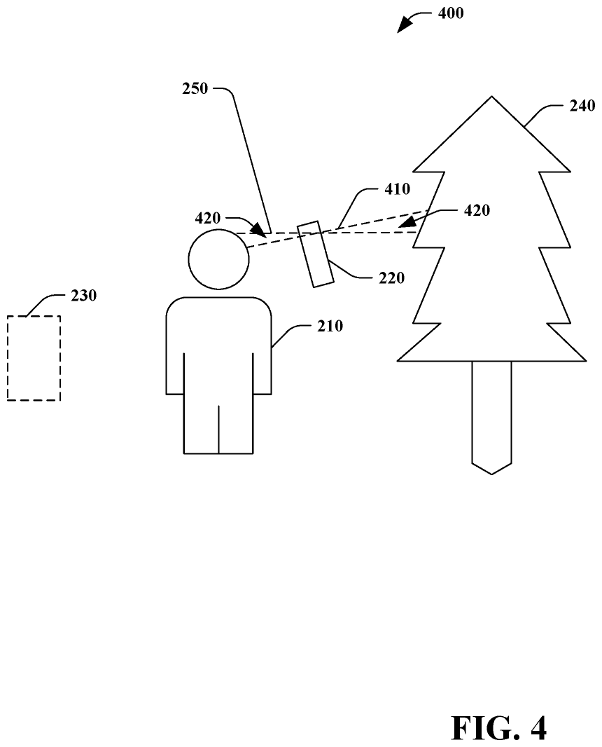

Turning briefly to FIG. 4, a diagram 400 illustrating the subject 210 having moved the user gaming device 220 resulting in a second three-dimensional axis 410 (e.g., orthogonal to the user gaming device 220). The second three-dimensional axis 410 and the first three-dimensional axis define/form an angle 420. In some embodiments, the angle 420 reflects a change of the user gaming device 220 in one dimension. In some embodiments, the angle 420 reflects a change of the user gaming device 220 in two dimensions. In some embodiments, the angle 420 reflects a change of the user gaming device 220 in three dimensions (e.g., six degrees of position).

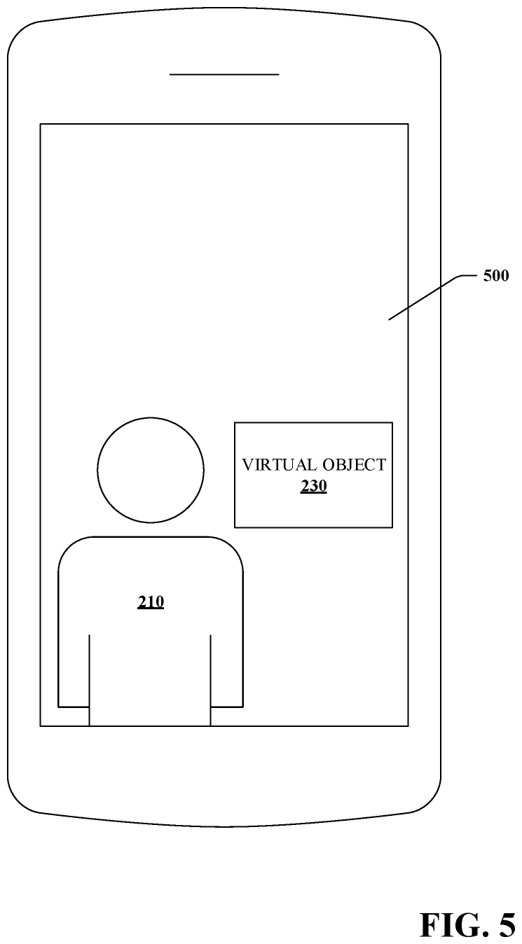

As illustrated in the exemplary user interface 500 of FIG. 5, based, at least in part, upon the movement of the user gaming device 220 by the angle 420, the system 100 can generate a self-portrait of the subject 210 overlaid/combined with the virtual object 230 viewable by display 510.

The system 100 includes a virtual object identification component 150 that identifies one or more virtual objects in proximity to the subject based, at least in part, upon the determined physical location and determined orientation of the user gaming device. As noted above, each virtual object has an associated physical location within the physical environment.

The system 100 includes a virtual object representation generation component 160 that based, at least in part, upon the determined distance of the subject/entity from the user gaming device, the determined physical location of the user gaming device, the determined orientation of the user gaming device, and, the identified one or more virtual objects in proximity to the entity, generates a representation (e.g., graphical) of the identified one or more virtual objects.

In some embodiments, due to a position of the user gaming device, no virtual objects are initially included in the self-portrait only those virtual object(s) having physical location(s) located behind the subject would appear in the A/R selfie. However, in response to one or more changes of position of the user gaming device, representation(s) of the identified one or more virtual objects can be generated.

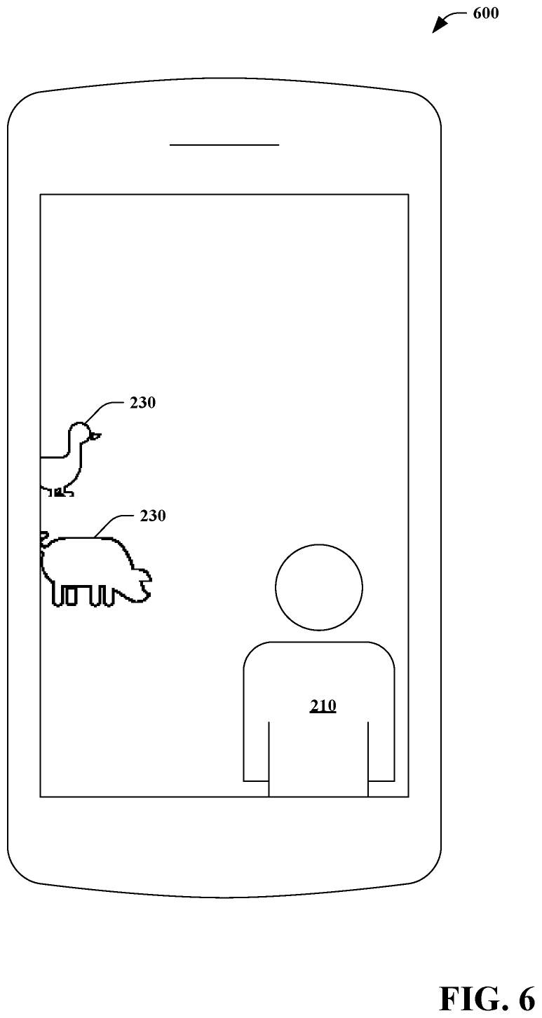

Referring briefly to FIG. 6, an exemplary user interface 600 is illustrated. The user interface 600 includes an image of the subject 210 and two virtual objects 230.

The user interface 600 includes two virtual object 230 for purposes of explanation and not limitation. The user interface 600 can include zero, one, or a plurality of virtual objects 230.

Portions of the virtual objects 230 are not displayed. Accordingly, the subject can move the user gaming device in one, two, or three-dimensions in order to adjust placement of the virtual objects 230 and/or the subject 210 within the user interface 600.

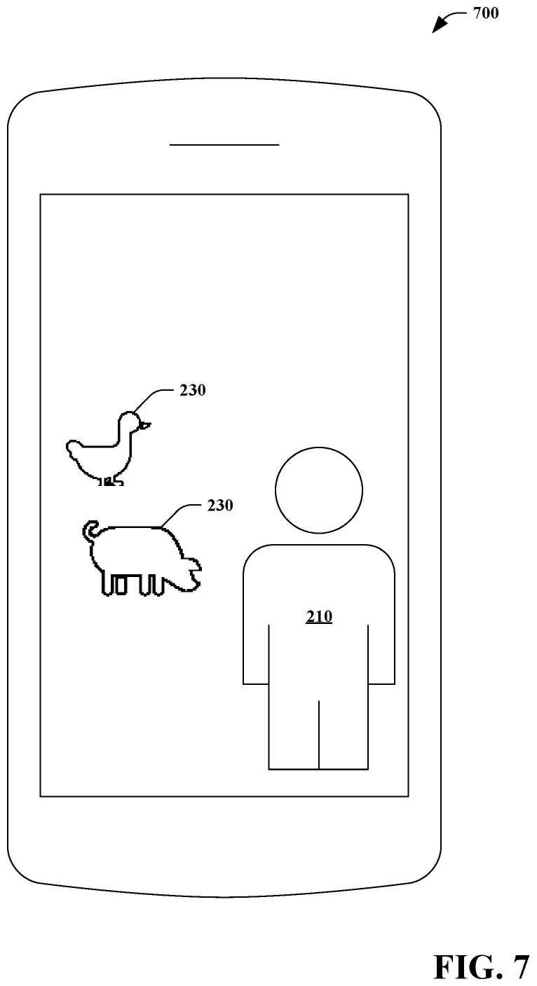

Turning to FIG. 7, an exemplary user interface 700 is illustrated. In this example, the subject 210 has adjusted the user gaming device such that the two virtual objects 230 are displayed within the user interface 700. The subject 210 can then cause a generated representation as displayed via the user interface 700 to be captured, for example, using a stop capture input (e.g., a soft input accessible via a display of the user gaming device, and/or a hard button of the user gaming device).

The system 100 includes an augmented reality subject representation component 170 that generates an augmented reality subject representation based, at least in part, upon a combination (overlaying) of the captured representation of the subject in the physical environment with the generated representation of the one or more identified one or more virtual objects.

In some embodiments, the system 100 can further include an output component 180 that displays the generated augmented reality subject representation on a display of the user gaming device. In some embodiments, the system 100 can further include a storage component 190 that stores the generated augmented reality subject representation for subsequent viewing and/or sharing.

In some embodiments, the identified virtual object(s) can respond to initiation of selfie-mode. In some embodiments, a particular animated virtual object can move away or towards the subject. In some embodiments, a particular animated virtual object can appear to interact with the subject. In some embodiments, a representation of a particular animated virtual object can change in appearance (e.g., color, size, animation) in response to initiation of selfie-mode.

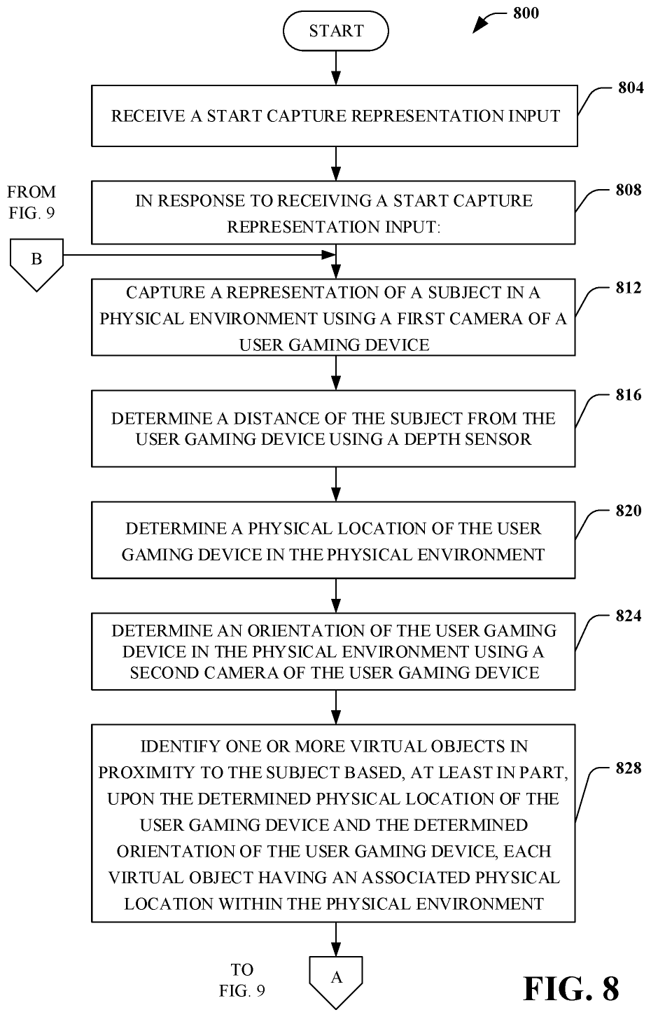

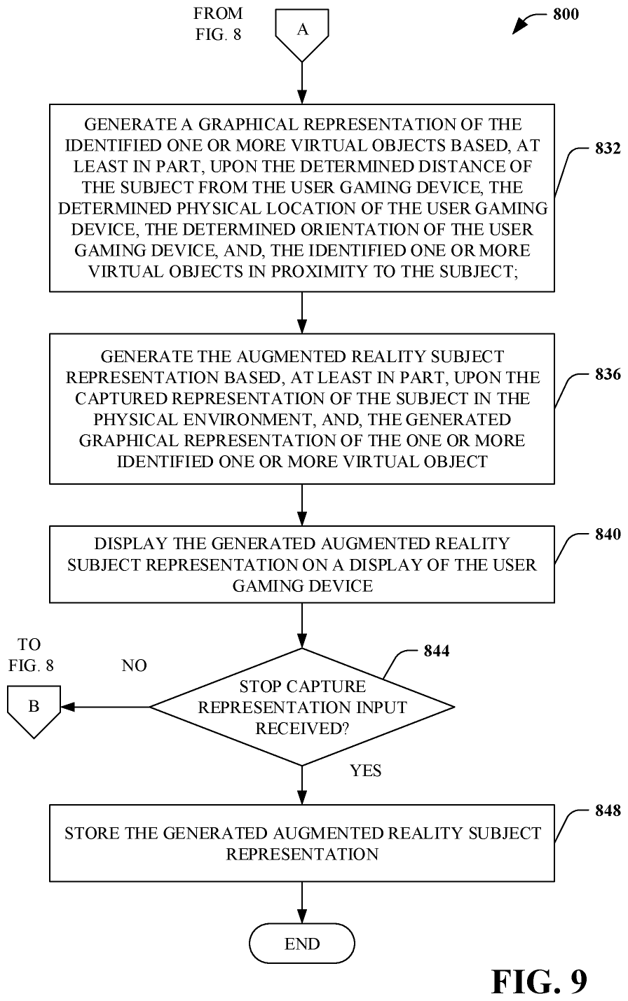

FIGS. 8-10 illustrate exemplary methodologies relating to generating/displaying an augmented reality subject representation. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 8, a method of generating an augmented reality subject representation 800 is illustrated. In some embodiments, the method 800 is performed by the system 100.

At 804, a start capture representation input is received. At 808, in response to receiving the start capture representation input, at 812, a representation of a subject in a physical environment is captured using a first camera of a user gaming device. At 816, a distance of the subject from the user gaming device is determined using a depth sensor;

At 820, a physical location of the user gaming device in the physical environment is determined. At 824, an orientation (e.g., six degrees of position or change in six degrees of position of the user gaming device) of the user gaming device in the physical environment is determined using a second camera of the user gaming device.

At 828, one or more virtual objects in proximity to the subject are identified based, at least in part, upon the determined physical location of the user gaming device and the determined orientation of the user gaming device, each virtual object having an associated physical location within the physical environment. At 832, a graphical representation of the identified one or more virtual objects is generated based, at least in part, upon the determined distance of the subject from the user gaming device, the determined physical location of the user gaming device, the determined orientation of the user gaming device, and, the identified one or more virtual objects in proximity to the subject.

At 836, the augmented reality subject representation is generated based, at least in part, upon the captured representation of the subject in the physical environment, and, the generated graphical representation of the one or more identified one or more virtual objects. At 840, the generated augmented reality subject representation is displayed on a display of the user gaming device.

At 844, a determination is made as to whether a stop capture representation input has been received. If the determination at 844 is NO, processing continues at 812. If the determination at 844, is YES, at 848, the generated augmented reality subject representation is stored.

Described herein is a system for generating an augmented reality subject representation, comprising: a computer comprising a processor and a memory having computer-executable instructions stored thereupon which, when executed by the processor, cause the computer to: capture a representation of a subject in a physical environment using a first camera of a user gaming device; determine a distance of the subject from the user gaming device using a depth sensor; determine a physical location of the user gaming device in the physical environment; determine an orientation of the user gaming device in the physical environment using a second camera of the mobile device; identify one or more virtual objects in proximity to the subject based, at least in part, upon the determined physical location of the user gaming device and the determined orientation of the user gaming device, each virtual object having an associated physical location within the physical environment; generate a graphical representation of the identified one or more virtual objects based, at least in part, upon the determined distance of the subject from the user gaming device, the determined physical location of the user gaming device, the determined orientation of the user gaming device, and, the identified one or more virtual objects in proximity to the subject; generate the augmented reality subject representation based, at least in part, upon the captured representation of the subject in the physical environment, and, the generated graphical representation of the one or more identified one or more virtual objects; and, display the generated augmented reality subject representation on a display of the user gaming device.

The system can further include wherein the representation comprises an image. The system can further include wherein the representation comprises a video. The system can further include wherein the first camera is a front-facing camera of the user gaming device, the first camera further comprising the depth sensor.

The system can further include wherein determining the physical location of the user gaming device in the physical environment is performed using at least one of the second camera of the user gaming device or GPS. The system can include the memory having further computer-executable instructions stored thereupon which, when executed by the processor, cause the computer to: store the generated augmented reality subject representation in a memory of the user gaming device. The system can include the memory having further computer-executable instructions stored thereupon which, when executed by the processor, cause the computer to: store the generated augmented reality subject representation in a cloud-based storage system.

Described herein is a method of generating an augmented reality subject representation, comprising: in response to receiving a start capture representation input: capturing a representation of a subject in a physical environment using a first camera of a user gaming device; determining a distance of the subject from the user gaming device using a depth sensor; determining a physical location of the user gaming device in the physical environment; determining an orientation of the user gaming device in the physical environment using a second camera of the user gaming device; identifying one or more virtual objects in proximity to the subject based, at least in part, upon the determined physical location of the user gaming device and the determined orientation of the user gaming device, each virtual object having an associated physical location within the physical environment; generating a graphical representation of the identified one or more virtual objects based, at least in part, upon the determined distance of the subject from the user gaming device, the determined physical location of the user gaming device, the determined orientation of the user gaming device, and, the identified one or more virtual objects in proximity to the subject; generating the augmented reality subject representation based, at least in part, upon the captured representation of the subject in the physical environment, and, the generated graphical representation of the one or more identified one or more virtual objects; and, displaying the generated augmented reality subject representation on a display of the user gaming device.

The method can be performed repetitively until a stop capture representation input is received. The method can further include storing the generated augmented reality subject representation in a memory of the user gaming device. The method can further include storing the generated augmented reality subject representation in a cloud-based storage system.

The method can further include wherein a particular virtual object of the identified one or more virtual objects changes at least one of an associated physical location within the physical environment, a size, a color, or an animation of the particular virtual object. The method can further include wherein the representation comprises an image or a video. The method can further include wherein the first camera is a front-facing camera of the user gaming device, and, the first camera further comprises the depth sensor. The method can further include wherein determining the physical location of the user gaming device in the physical environment is performed using at least one of the second camera of the user gaming device or GPS.

Described herein is a computer storage media storing computer-readable instructions that when executed cause a computing device to: capture a representation of a subject in a physical environment using a first camera of a user gaming device; determine a distance of the subject from the user gaming device using a depth sensor; determine a physical location of the user gaming device in the physical environment; determine an orientation of the user gaming device in the physical environment using a second camera of the user gaming device; identify one or more virtual objects in proximity to the subject based, at least in part, upon the determined physical location of the user gaming device and the determined orientation of the user gaming device, each virtual object having an associated physical location within the physical environment; generate a graphical representation of the identified one or more virtual objects based, at least in part, upon the determined distance of the subject from the user gaming device, the determined physical location of the user gaming device, the determined orientation of the user gaming device, and, the identified one or more virtual objects in proximity to the subject; generate the augmented reality subject representation by based, at least in part, upon the captured representation of the subject in the physical environment, and, the generated graphical representation of the one or more identified one or more virtual objects; and, display the generated augmented reality subject representation on a display of the user gaming device.

The computer storage media can further include wherein the first camera is a front-facing camera of the user gaming device, the first camera further comprising the depth sensor. The computer storage media can further include wherein determining the physical location of the user gaming device in the physical environment is performed using at least one of the second camera of the user gaming device or GPS. The computer storage media can store further computer-readable instructions that when executed cause the computing device to: store the generated augmented reality subject representation in a memory of the user gaming device. The computer storage media can store further computer-readable instructions that when executed cause the computing device to: store the generated augmented reality subject representation in a cloud-based storage system.

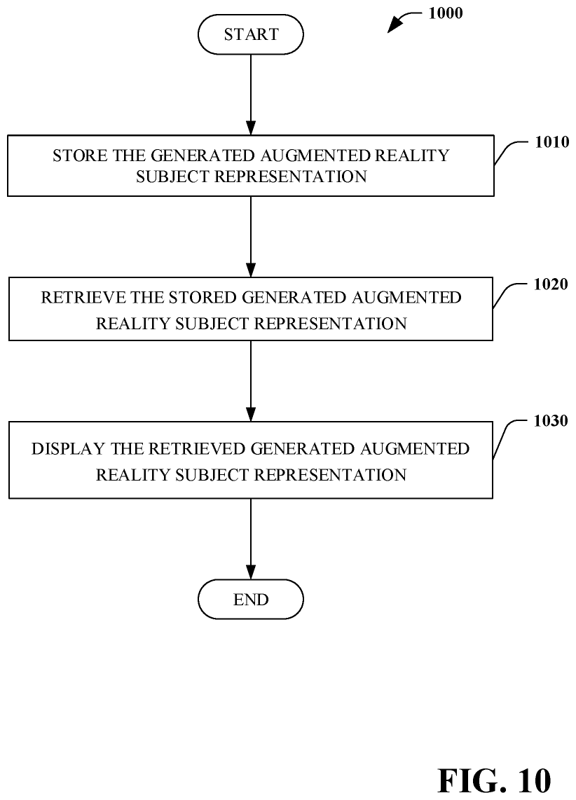

Turning to FIG. 10, a method of viewing a generated augmented reality subject representation is illustrated. At 1010, a generated augmented reality subject representation is stored (e.g., in memory/storage of a user gaming device, and/or in cloud-based storage). At 1020, the stored generated augmented reality subject representation is retrieved. At 1030, the retrieved generated augmented reality subject representation is displayed.

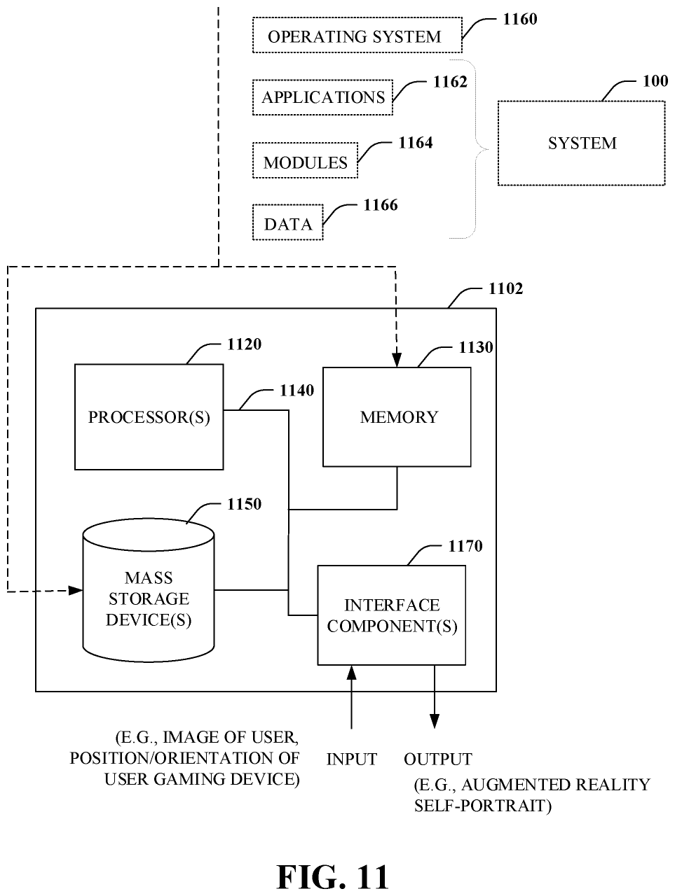

With reference to FIG. 11, illustrated is an example general-purpose computer or computing device 1102 (e.g., mobile phone, desktop, laptop, tablet, watch, server, hand-held, programmable consumer or industrial electronics, set-top box, game system, compute node, etc.). For instance, the computing device 1102 may be used in a system for generating an augmented reality subject representation.

The computer 1102 includes one or more processor(s) 1120, memory 1130, system bus 1140, mass storage device(s) 1150, and one or more interface components 1170. The system bus 1140 communicatively couples at least the above system constituents. However, it is to be appreciated that in its simplest form the computer 1102 can include one or more processors 1120 coupled to memory 1130 that execute various computer executable actions, instructions, and or components stored in memory 1130. The instructions may be, for instance, instructions for implementing functionality described as being carried out by one or more components discussed above or instructions for implementing one or more of the methods described above.

The processor(s) 1120 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1120 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 1120 can be a graphics processor.

The computer 1102 can include or otherwise interact with a variety of computer-readable media to facilitate control of the computer 1102 to implement one or more aspects of the claimed subject matter. The computer-readable media can be any available media that can be accessed by the computer 1102 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 1102. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 1130 and mass storage device(s) 1150 are examples of computer-readable storage media. Depending on the exact configuration and type of computing device, memory 1130 may be volatile (e.g., RAM), non-volatile (e.g., ROM, flash memory, etc.) or some combination of the two. By way of example, the basic input/output system (BIOS), including basic routines to transfer information between elements within the computer 1102, such as during start-up, can be stored in nonvolatile memory, while volatile memory can act as external cache memory to facilitate processing by the processor(s) 1120, among other things.

Mass storage device(s) 1150 includes removable/non-removable, volatile/non-volatile computer storage media for storage of large amounts of data relative to the memory 1130. For example, mass storage device(s) 1150 includes, but is not limited to, one or more devices such as a magnetic or optical disk drive, floppy disk drive, flash memory, solid-state drive, or memory stick.

Memory 1130 and mass storage device(s) 1150 can include, or have stored therein, operating system 1160, one or more applications 1162, one or more program modules 1164, and data 1166. The operating system 1160 acts to control and allocate resources of the computer 1102. Applications 1162 include one or both of system and application software and can exploit management of resources by the operating system 1160 through program modules 1164 and data 1166 stored in memory 1130 and/or mass storage device (s) 1150 to perform one or more actions. Accordingly, applications 1162 can turn a general-purpose computer 1102 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 1162, and include one or more modules 1164 and data 1166 stored in memory and/or mass storage device(s) 1150 whose functionality can be realized when executed by one or more processor(s) 1120.

In some embodiments, the processor(s) 1120 can correspond to a system on a chip (SOC) or like architecture including, or in other words integrating, both hardware and software on a single integrated circuit substrate. Here, the processor(s) 1120 can include one or more processors as well as memory at least similar to processor(s) 1120 and memory 1130, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 1102 also includes one or more interface components 1170 that are communicatively coupled to the system bus 1140 and facilitate interaction with the computer 1102. By way of example, the interface component 1170 can be a port (e.g., serial, parallel, PCMCIA, USB, FireWire, etc.) or an interface card (e.g., sound, video, etc.) or the like. In one example implementation, the interface component 1170 can be embodied as a user input/output interface to enable a user to enter commands and information into the computer 1102, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 1170 can be embodied as an output peripheral interface to supply output to displays (e.g., LCD, LED, plasma, etc.), speakers, printers, and/or other computers, among other things. Still further yet, the interface component 1170 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

1. A device, comprising:
a display;
a depth sensor;
a first camera;
a processor; and
a memory having computer-executable instructions stored thereupon which, when executed by the processor, cause the device to:
capture a representation of a subject in a physical environment using the first camera;
determine a distance of the subject from the device using the depth sensor;
determine a physical location of the device in the physical environment;
determine an orientation of the device in the physical environment;
identify one or more virtual objects that are anchored to one or more corresponding physical locations in the physical environment in proximity to the subject based, at least in part, upon the physical location of the device and the orientation of the device;
generate a graphical representation of the one or more virtual objects based, at least in part, upon the distance of the subject from the device, the physical location of the device, and the orientation of the device;
generate an augmented reality subject representation based, at least in part, upon the captured representation of the subject in the physical environment and the graphical representation of the one or more virtual objects; and,
display the augmented reality subject representation on the display of the device, the augmented reality subject representation showing the subject located in the physical environment relative to the one or more virtual objects that are anchored at the one or more corresponding physical locations in the physical environment.

2. The device of claim 1, wherein the augmented reality subject representation comprises an image.

3. The device of claim 1, wherein the augmented reality subject representation comprises a video.

4. The device system of claim 1, wherein the first camera is a front-facing camera of the device, the first camera further comprising the depth sensor.

5. The device of claim 1, wherein the physical location of the device in the physical environment is determined using at least one of a second camera of the device or GPS.

6. The device of claim 1, the memory having further computer-executable instructions stored thereupon which, when executed by the processor, cause the device to:
store the augmented reality subject representation locally on the device.

7. The device of claim 1, the memory having further computer-executable instructions stored thereupon which, when executed by the processor, cause the device to:
store the augmented reality subject representation in a cloud-based storage system.

8. A method comprising:
capturing a representation of a subject in a physical environment using a first camera of a user device;
determining a distance of the subject from the user device using a depth sensor;
determining a physical location of the user device in the physical environment;
determining an orientation of the user device in the physical environment using a second camera of the user device;
identifying one or more virtual objects that are anchored to one or more corresponding physical locations in the physical environment in proximity to the subject, the one or more virtual objects being identified based, at least in part, upon the physical location of the user device and the orientation of the user device;
generating a graphical representation of the one or more virtual objects based, at least in part, upon the distance of the subject from the user device, the physical location of the user device, and the orientation of the user device;
generating an augmented reality subject representation based, at least in part, upon the captured representation of the subject in the physical environment and the graphical representation of the one or more virtual objects; and,
displaying the augmented reality subject representation on a display of the user device, the augmented reality subject representation showing the subject located in the physical environment relative to the one or more virtual objects that are anchored at the one or more corresponding physical locations in the physical environment.

9. The method of claim 8 performed repetitively in response to a start capture representation until a stop capture representation input is received.

10. The method of claim 9, further comprising:
storing the augmented reality subject representation in a memory of the user device.

11. The method of claim 9, further comprising:
storing the augmented reality subject representation in a cloud-based storage system.

12. The method of claim 9, further comprising:
changing at least one of a size, a color, or an animation of a particular virtual object.

13. The method of claim 8, wherein the augmented reality subject representation comprises an image or a video.

14. The method of claim 8, wherein the first camera is a front-facing camera of the user device, and, the first camera further comprises the depth sensor.

15. The method of claim 8, wherein determining the physical location of the user device in the physical environment is performed using at least one of the second camera of the user device or GPS.

16. A computer storage media storing computer-readable instructions that, when executed, cause a processor to:
obtain a representation of a subject in a physical environment, the representation being captured by a first camera of a device;
obtain a distance of the subject from the device;
obtain a physical location of the device in the physical environment;
obtain an orientation of the device in the physical environment;
identify one or more virtual objects that are anchored to one or more corresponding physical locations in the physical environment in proximity to the subject based, at least in part, upon the physical location of the device and the orientation of the device;
obtain a graphical representation of the one or more virtual objects based, at least in part, upon the distance of the subject from the device, the physical location of the device, and the orientation of the device;
generate an augmented reality subject representation based, at least in part, upon the representation of the subject in the physical environment and the graphical representation of the one or more virtual objects; and,
output the augmented reality subject representation for presentation.

17. The computer storage media of claim 16, storing further computer-readable instructions that, when executed, cause the processor to:
prior to generating the augmented reality subject representation, disperse a plurality of virtual objects within the physical environment by anchoring the plurality of virtual objects at different physical locations.

18. The computer storage media of claim 16, wherein the physical location of the device in the physical environment is determined using GPS.

19. The computer storage media of claim 16, wherein the augmented reality subject representation includes at least part of the physical environment other than the subject and other than the one or more virtual objects.

20. The computer storage media of claim 16, wherein the one or more virtual objects are separate from the subject and are not shown in the augmented reality subject representation as being in contact with the subject.
